(19) United States
(12) Patent Application Publication
(10) Pub. No.: US 2002/0083123 A1
(43) Pub. Date: Jun. 27, 2002

(54) System and method for accessing network resources from encoded source data

(76) Inventors: David Freedman, New York, NY (US); Adrian Sinclair, Rutherford, NJ (US)

Correspondence Address: HANDAL & MOROFSKY, 80 WASHINGTON STREET, NORWALK, CT, 06854, US

(21) Appl. No.: 09/749,259

(22) Filed: Dec. 27, 2000

(51) Int. Cl. G06F 15/16

(52) U.S. Cl. 709/203; 709/219

(57) ABSTRACT

A method is disclosed for supplying information from a network, such as the Internet, through, for example, a computing device to consumers on request. An optically readable indicia on an object is optically scanned to create an electronic representation of the indicia. The indicia can be visible or invisible, including invisible ink barcoding and digital watermarking. The electronic representation is used by a computing device to communicate with a central server. The central server selects a network address from a plurality of addresses that are or may come to be associated with the indicia. Selection is made in response to selected criteria so that the indicia is associated with different addresses based upon differences in the selected criteria. The central server contacts a server at the selected network address and obtains information from the server associated with the address. The central server communicates the information received from the server back to the computing device for display or other use at the computing device.

### BACKGROUND

The Internet has provided an important means of information communication and retrieval. Increasingly, the Internet is also providing access to electronic commerce. Consumers are becoming more comfortable with buying products on-line and getting valuable information with which to make buying decisions. However, many consumers are unfamiliar with the complexities of performing network searches and, more significantly, are accustomed to acquiring product information through traditional print and broadcast media. This seems likely to continue indefinitely into the future.

Providers have attempted to take advantage of conventional media in connection with Internet based advertisement protocols by supplying their network addresses in their print and electronic advertisements. A consumer who is sophisticated enough will copy the address and access the information resource on the Internet. This allows consumers to be directed to the seller's electronic store where the consumer may be directed to additional products and services. Unfortunately, not all consumers are sophisticated in this respect and, regardless, may be unwilling to act at the moment of interest. For these consumers a simple and effortless system of network access is needed.

Presently, throughout the world, print media are particularly effective. This is the case because (1) it is the most ubiquitous method of communication and advertising in the modern world; and (2) a printed document can serve as a persistent reference to be saved and used on subsequent occasions.

However, human readable printed addresses are particularly inconvenient to enter manually in software programs, such as web browsers, due to their length and use of complex and unfamiliar symbols. If the characters in a URL are not entered exactly, retrieval is prevented or, in a limited number of cases, a legal but incorrect source is accessed. This is especially true when URLs incorporate foreign languages and/or complex query instructions to on-line databases, as is increasingly frequent in web sites today. In addition, the inability to type or otherwise manually enter symbolic address information due to either disability or lack of training complicates use of on-line information resources, such as the Internet, for millions of individuals.

Finally, it is widely anticipated that Internet access will increasingly be provided through interactive cable television via web-ready television receivers and set-top boxes used in conjunction with conventional television receivers. In this home entertainment environment, it is difficult to use keyboards for address entry due to both lack of typing skill and the cumbersome placement of these components. Accordingly, any other methods which can eliminate typing and allow users to directly link printed addresses and query scripts to electronic information resources would be highly desirable.

Companies that host web sites for the purpose of providing information such as advertising, often want to know identity and other related information on the consumers who visit their sites (i.e., download files therefrom). It will be quite advantageous to provide such companies or vendors with this information as part of a specific file transfer request. Additionally, it would be desirable to be able to effect a secure manner of transferring this information, so that a consumer would have confidence in the system and thus send sensitive information such as a credit card number or the like with the file transfer request.

U.S. Pat. No. 5,933,829 to Durst, et al. describes a system of providing automated access via a network to information stored in a file. The disclosed system utilizes a machine readable code printed on a label to launch a network program and take the consumer to a network address encoded thereon. The application of such an encoded and printed label is limited because it must be distributed by the vendor to the end user.

U.S. Pat. No. 6,012,102 to Shachar provides a system for creating a machine readable code on a printed label and using that code for access to a network resource. The disclosed technique illustrates replacing a sequence of address characters with a symbol thereby allowing for printing of the network address where there is a space limitation.

U.S. Pat. No. 6,045,048 to Wilz, Sr., et al. discloses a system for collecting and subsequently printing bar coded labels of network addresses. This system does not provide any specific means by which a label is placed on a physical object with the label encoded with a resource address associated with the object.

### SUMMARY OF THE INVENTION

The present invention discloses a method for supplying information to consumers on request. This is accomplished by composing an optically readable indicia. The optically readable indicia is applied to an object. The consumer optically scans the indicia to generate an electronic representation of the indicia. After the consumer optically scans one or more of the indicia, the electronic representation of the indicia is stored in the scanner device that was used to perform the optical scanning. At a later point in time, the electronic representation may thus be downloaded to a computing device. The device is portable, allowing scanning to be done without the advantage of a computer.

The computing device is then caused to communicate a signal to a central server. The communicated signal includes information which identifies the optically readable indicia. The central server is programmed to associate the optically readable indicia with one of a plurality of associated addresses in response to selected criteria. This results in associating the optically readable indicia with different addresses in response to differences in the selected criteria. The central server is responsive to the signal i) to contact a server at an address associated with the signal and the optically readable indicia at the time of the contacting of the server, and ii) obtain information from the server associated with the address and communicate the information received from the server associated with the address to the computing device for display or other use at said computing device.

After the consumer optically scans the indicia to generate an electronic representation of the indicia, the electronic representation of the indicia is stored in the scanner device, that was used to perform the optical scanning. At a later point in time, the electronic representation may thus be downloaded to a computing device unless the scanner is a wireless device that can access the Internet, such as a PDA or cell phone.

### BRIEF DESCRIPTION OF THE DRAWINGS

The present invention will now be described, by way of example only, with reference to the accompanying drawings in which:

FIG. 1 is a step diagram of the inventive system;

FIG. 2 is a flowchart illustrating the method of the present invention;

FIG. 3 is a flowchart illustrating the creation and editing of a resource link device;

FIG. 4 is a flowchart illustrating the client consumer software;

FIG. 5 is a flowchart illustrating the rendering of a resource link device;

FIG. 6 is a flowchart illustrating how resource link devices are resolved into network addresses; and

FIG. 7 is a flowchart of the resource link device routing method which is system callable by other subsystems.

### DETAILED DESCRIPTION OF THE INVENTION

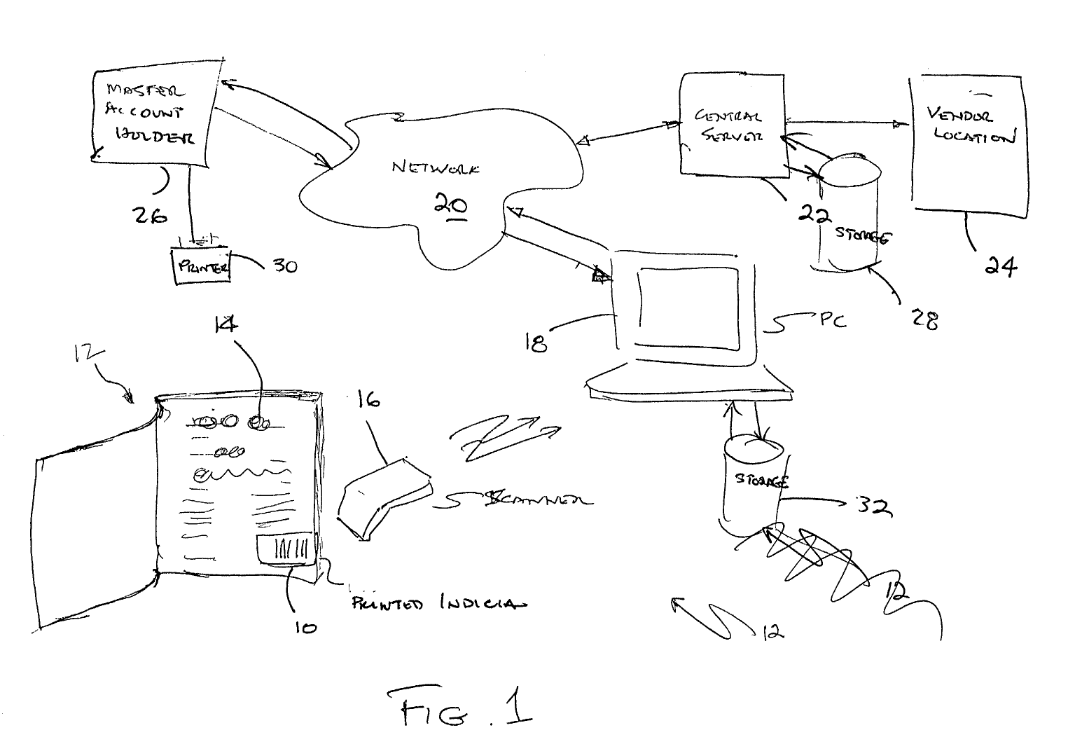

As illustrated in FIG. 1, the method of the present invention may be implemented in the form of a printed indicia 10. In accordance with the present invention, printed indicia 10 functions as an informational link for a consumer using the system of the present invention to scan printed indicia 10 for later input to a personal computer to obtain information associated with a network address or instantaneous access if the scanner is a wireless device that can access the Internet, such as a PDA or cell phone.

Indicia 10 may be implemented in a variety of ways. For example, in a printed member, such as a magazine 12, incorporating the technology of the invention, printed indicia 10 is printed on a page 14, which may comprise a magazine advertisement. Alternatively, printed indicia may be applied to any other object capable of receiving the same, such as a poster, newspaper article, store window, legal notice, lottery ticket, article for sale, etc.

In accordance with the present invention, printed indicia 10 takes the form of a machine readable code with an informational content which will be described in detail below. Generally, however, it is contemplated that in accordance with the present invention, the machine readable code is used to input an address and other information through a handheld device. In accordance with a preferred embodiment of the invention, a consumer has a scanner 16 which functions much like a bar code reader to read the information contained within printed indicia 10. Such information may be stored in the scanner and downloaded at a later time. Alternatively, scanner 16 may be directly coupled to a personal computer 18 and, or be an Internet-enabled wireless device, and at the time of scanning printed indicia 10, instantly convert the information and send the same to personal computer 18.

In accordance with the present invention, scanner 16 may be connected to personal computer 18 by an infrared link. While the transfer of information over infrared links is relatively slow, the information density of the information contained within printed indicia 10 is very low, being in the nature of a numeric database key with minimal additional information, and, accordingly, such an infrared link provides relatively quick and convenient coupling of the information. Alternatively, the scanner can transmit the information via BLUETOOTH (trademark) wireless technology, or a direct connection to a communication port. Likewise, in accordance with the present invention, it is contemplated that scanner 16 is battery-powered.

Once the address has been transferred to personal computer 18, in accordance with the invention, the informational output generated from printed indicia 10 may be stored for later use. Alternatively, the information may be immediately used to obtain content over a network 20, to which personal computer 18 is connected. Once the network connection is implemented, the consumer's personal computer 18 is provided with content from an advertiser location 24 through a central server 22.

In the inventive system the resource link device directs a consumer to a central server 22 on a network. The central server 22 will redirect the consumer on to an ultimate address 24. The ultimate address or site is the ultimate destination of the consumer. Central server 22 will maintain the links from printed indicia 10 to the ultimate destination 24. The transfer of sites may be either transparent to the consumer or central server may offer information prior to sending the consumer on to ultimate location 24. This arrangement is preferable to a fixed referral address, as this allows central server 22 to alter the indicia-originated query to different locations at different times, or on subsequent actuations of the query from a particular personal computer. This allows, for example, a series of sales messages to be sent to a single consumer.

In accordance with a preferred embodiment of the invention, scanner 16 scans printed indicia 10 and stores the same in a small onboard memory capable of storing the informational content of many such printed indicia. Indeed, in accordance with present technology, storing hundreds or even thousands of such informational sets is trivial and extremely cost effective. Printed indicia have a content which points to resource link device records which in the preferred embodiments also include hidden fields for receiving consumer data. This allows the resource link device record to serve as a generator of customized consumer specific addresses which are stored in a central database storage 28 on central server 22. Resource link device records in addition to having address information also, in accordance with the preferred embodiment, also include hidden fields for receiving consumer data. This allows the resource link device records to serve as a data entry screen for the generation of customized consumer specific data to be supplied by the consumer or to be filled in by the system in communication with the consumer. The resource link device record thus provides a vehicle to receive consumer information to generate a resource link device record which has the information in the uncustomized version of the consumer information. In other words there is provided means for recording data to provide an association for the hidden fields between data in printed indicia 10, and other information as described further herein below.

Some of the data for the hidden fields may be provided also by a master account holder 26, such as an advertiser using an indicia in an advertisement: Master account holder 26 connects through the Internet or another network to central server 22. Master account holder 26 provides information to central server 22. Said information is used in the creation of indicia 10 and stored in a database of resource link device records other information for the resource link device records is supplied by the consumer.

In the case of consumer information, this information provided to the system by the consumer who is provided with a form on the display of computer 18 at the time the consumer selects a particular indicia 10 from a menu of indicia collected by scanner 16 and computer 18 fetches the relevant information from central server 22.

It is contemplated that the data provided to the consumer will include such items as a title, description, and other such basic useful identifier data. As alluded to above, the information so supplied is also associated with the resource link device record and stored in a central server database storage 28.

Also associated with the resource link device record is information that will not be supplied to the consumer. It is contemplated that additional data such as the URL of the ultimate consumer destination (which may or may not be displayed to the consumer), billing requirements, length of service provided, etc. will also be associated with the resource link device record and stored in central storage database 28. This data also provides for interaction between central server 22 and master account holder 26 or others authorized by master account holder 26. Alternatively, the menu could be created on a remote server and be accessible from any computer connected to the web. Master account holder 26 may render the indicia into its final form. In a particular embodiment of the present invention the indicia may be printed on a printer 30.

The menu for the resolution of a download associated with a particular printed indicia 10 is created by software resident within computer 18. Alternatively, the menu could be created on a remote server and be accessible from any computer connected to the Web. The resident software displays information associated with the resource link device record that is pointed to by indicia 10 provided from central server 22. This may be a company name, product name, attention getting line (“Save $50 on your next PC”), or the like. Additionally, a local PC database storage device associated with the PC of the consumer maintains data private to the consumer. This data may include the consumer's credit card number, date of birth, age, physical location, etc. This data is provided as appropriately required to central server 22 for usage during a consumer initiated session. Billing information could alternatively be stored in a central server “wallet”. Certain information such as consumer-id may be needed at sign-on time as a parameter to allow the consumer access to central server 22. Other information such as physical location may also be used at sign-on for central server 22 to provide a responsive and appropriate resource link device record. Finally, data such as a consumer's credit card number may only be used at the time of purchase and, appropriately, only with the consumer's knowledge and agreement. It should be noted that it is envisioned and anticipated by the present invention that data may be encrypted.

The indicia could also be printed in invisible ink that glows under near-infrared (NIR) or ultraviolet (UV) light, overlaid on top of an easily identified visual cue. Such an embodiment would enable a linear bar code to be used with minimal design impact of the printed surface. Inexpensive scanning hardware exists that is capable of reading bar codes in invisible ink. In yet another embodiment, the indicia could be unobtrusively embedded in a region of the printed surface via digital watermarking technology.

It is also contemplated in accordance with this embodiment of the invention that the scanner may be dedicated to a special type of coded indicia 10 or may be a general purpose device, also of marking a plurality of bar code types, or alpha numeric or logo-type characters. The indicia could also be printed in invisible ink that glows under near-infrared (NIR) or ultraviolet (UV) light, overlaid on top of an easily identified visual cue. Such an embodiment would enable a linear bar code to be used with minimal design impact of the printed surface. Inexpensive scanning hardware exists that is capable of reading bar codes in invisible ink. In yet another embodiment, the indicia could be unobtrusively embedded in a region of the printed surface via digital watermarking technology. Such “printed” indicia may comprise printing on a magazine page, or magazine cover, printing on a poster, the display on a television screen, or a price a sticker on a product in a store.

Also in accordance with this embodiment of the invention, it is contemplated that the printed indicia 10 may relate to the actual object upon which it is printed. For example, if indicia 10 is printed on a magazine, the printed indicia 10 provides an informational link to information on the magazine. This may constitute the number of pages, squibs on various articles printed, and the like. If indicia 10 is printed on a label attached to a pair of jeans, the informational content may relate to the particular clothing involved. This may be available colors, sizes washing instructions, photographs of models wearing the clothing, and so forth. If indicia 10 is on a movie poster, the informational link may provide links to information on movie reviews, movie length, recommended viewers, content, a summary of the story, and other sales information.

Also in accordance with the present invention, the informational content associated with the inventive printed indicia may relate to something other than the actual object on which the printed indicia is located. For example, in the case of a television show, the scanner may scan an informational link or address connected with related programming. If the printed indicia is located on the page of a magazine, and that page is an advertisement, as illustrated in FIG. 1, the link may be to the advertiser's web site.

The resource link device invention may be embodied in articles other than print media. It is anticipated that the resource link device may be encoded in audible, subsonic or ultrasonic tones transmitted via electronic media such as radio or television. The tones, if audible, may pleasingly constitute sounds of an entertaining nature, such as the well known Microsoft “wave” sounds, which are played during advertisements placed in the media by that software provider. In accordance with the present invention, it is contemplated that the tones will not necessarily be of a mechanical nature in which all companies share the same set of sounds. More particularly, in accordance of the invention, it is contemplated that a discrete number of fundamental frequencies will serve as information bearing signals and may be associated with television programming, a videocassette recording, a radio transmission, or the like.

Such audible signals may take many forms in accordance with the present invention. For example, the signals may be tones having fundamental frequencies selected from the group consisting of the frequencies 300 Hz, 400 Hz, 500 Hz, 600 Hz, 700 Hz, 800 Hz, 900 Hz and 1000 Hz. In order to reduce the likelihood of a false detection of a tone, one or two additional tones may be associated with each of the fundamental frequencies. In addition, to build aesthetic acceptability of the sounds, other frequencies, in varying amplitudes, and or frequencies selected not to confuse the system, are added for simultaneous or sequential generation to create a pleasing overall sound pattern. The other element to reduce the likelihood of false detection of an informational link is maintaining a predetermined pattern of a plurality of tones.

Accordingly, if the system is implemented as detailed above, eight possible different tones are provided. Thus, if three of these tones are used in only one amplitude for each informational link, the system has a capacity of 8 to the power of 3, or 512 tone indicia. Doubling the number of tones results in 250,000 possible tone indicia.

In accordance with one preferred embodiment of the invention, tone indicia may be used in conjunction with a television or radio program to wed digital media, such as the Internet, to conventional media, such as a radio or television program. In addition, tone indicia may be used in connection with such media as video cassette recordings, theater presentations of movies, political advertisements, product advertisements and so forth.

Tone indicia also have the added advantage of providing an audible queue to an individual listing to, for example, a television program. In accordance with a particularly preferred embodiment of the inventive system utilizing audible tone indicia, during the course of a television broadcast, a sequence of tone indicia are transmitted at relevant portions of the television program. For example, if the program consists of a series of interviews of different individuals, audible tone indicia would be transmitted periodically during the interview of each individual and thus would signal the listener to activate his computer. As the tones are transmitted, in accordance with this embodiment of the invention, the tones are received by the microphone provided on the computer. Such microphones are very common, for example, being standard equipment on virtually all laptop computers for many years. Thus an individual watching a television program would be signaled to turn on his computer, and after turning the computer on, the computer would receive the tones transmitted during the course of the television program and provide supplementary informational content on the screen of the computer. This information varies from time to time as different tone indicia are transmitted during the course of a program.

Moreover, the system has the advantage of being able to provide secondary channel information over the computer even when the program is not being transmitted, for example, if the program has been previously recorded by the listener and played back at a more convenient hour.

Moreover, in the case of tone indicia, the information available at the website that the tone indicia point to may be vary from time to time. For example, more up-to-date information may be provided, or, in order to maintain interest at a later date, different information could be provided. For example, in the case of programs dealing with music or the dance, listeners may be encouraged to see certain performances repeatedly because of the enjoyment associated with the same. Interest in the repeated performance could be raised to even greater levels during second and subsequent showings of the performance by having new and different information associated with the “Internet” channel of entertainment associated with the particular performance, which would be triggered in the form of sequential screens of alphanumeric data, video information, streaming video, illustrations and the like by tone indicia during the course of the re-broadcast, or a replay of a previously recorded performance.

In accordance with the use of the Internet and tone indicia, as described above, it is also possible that the tone indicia may be stored, at the viewer's option, for reading or viewing at a later time. As alluded to above, in accordance with the invention it is contemplated that a coded visual resource link, such as a bar code may be read from a video display, such as a television screen or a computer display on a computer connected to a web site. In both of these cases, a resource link 10 may be encoded as a visual representation of a bar code or other encoding device. Alternative graphic representations obvious to those of ordinary skill in the art are within the purview of the invention, as claimed.

The resource link device such as printed indicia 10 or an audible tone indicia is encoded with an address for the central server 22 and information which is read by the server to retrieve the universal resource locator (URL) or other network addresses of the desired content. The central server may present an informational banner or transparently redirect the consumer onto the provider's ultimate location. Attributes associated with the resource link device or the consumer will affect the ultimate site selected by the central server. The redirection to the ultimate destination may be affected by indicators such as (1) a direct site address supplied by the clients on the sites and/or (2) particular consumer attributes and/or (3) information encoded within the resource link device.

As alluded to above, in accordance with the present invention, the inventive resource link devices, such as printed indicia 10 or audible tone indicia, are not simply a network address. Rather, they contain information which directs the inquiry to a central server which makes the decision with respect to what information will be produced in response to the inquiry. In the simplest case, this may be merely to redirect the inquiry to the particular website in every instance. Alternatively, the system may direct the inquiry to different addresses at different periods of time.

In addition, in accordance with the present invention, it is contemplated that the inquiry will be logged, and this information used to determine information sent to the person making the inquiry by transmitting the information content of the inventive resource link. For example, if the resource link is being used a third time, the system may decide to provide different information meant to supplement prior information given during the first and second use of the resource link.

The inventive system also provides a method for versatile redirection of a consumer from a central server based upon attributes associated with the resource link device or the consumer. For example, the resource link many have encoded in it the particular source for the link. For example, the link may show that it was scanned from the Wall Street Journal, thus dictating different treatment from a resource link scanned from the TV Guide. Attributes associated with the resource link device are encoded therein by any suitable method or structure. These encodings provide the central server with detailed information whereby the consumer is redirected to a site that is more closely aligned with his or her needs.

As an example, redirection may be based upon a temporal aspect of a product advertisement. Based upon the date of the advertisement, the central server can conclude that more up-to-date products are available and, therefore, redirect the consumer to a site other than the one associated with the original advertisement. Such redirection may be accompanied with an explanation for that redirection Computer products that change often are amenable to such redirection. Similarly, fruits that were in season at the time of a particular advertisement incorporating a resource link in accordance with the present invention may now be out of season but an attractive alternative is available. Implementation of an inquiry (on strawberries, for example) by, for example, double-clicking on an icon associated with a particular resource link will then bring the computer making the inquiry to the central server where the central server will direct the inquiry to a site with the information on the particularly attractive alternative. (In this example, a site on cherries).

Collateral sites may also be provided. Following the example of the fruits, a redirected site may include recipes using the fruit, which might be implemented during second and subsequent inquiries respecting the same. Alternatively, the vendor of the original advertisement may no longer be in business. The central server can redirect the consumer to a site wherein a competitive product is offered, thus allowing transfer of the goodwill associated with the site to others, a payment to the original owner of the indicia 10 may also be provided.

“Location” is another factor encoded in the resource link device that provides the central server with information to redirect the consumer to a particular network site. “Location” includes the physical location of the resource link (e.g., magazine, newspaper, poster, etc., as alluded to above) as well as the geographical location where the resource link device was found. As an example of the physical location, the central server may determine the needs of a reader of Mechanix Illustrated as different from those of a reader of Prevention Magazine, even though both readers entered a scan of a resource link device such as indicia 10 associated with the same advertisement. The redirected sites in this example may offer the same product but use different marketing techniques, or present different types of information in order to build and hold reader interest.

Alternatively, the inventive indicia coming from different geographical locations can, as an example, promote a vendor in the same geographical area as the consumer making the inquiry to the activation of a resource link. Automobile dealerships fit into this category.

Another application of the resource link device invention is in generic ads. An example here is redirection of a consumer interested in an ad from the Milk Association. Yet another application is for political advertisements. In this case a consumer may be directed to a local political action group, political party, or generic site (e.g., the republican or democrat national committee).

The resource link device invention is particularly well suited to public service advertisements. Missing children and charities which require redirection to local sites wherein information may be found or donations given. Local governments can have users redirected to particular sites to get forms and documents by email.

The central server redirects a consumer based on consumer characteristics as well. A user that has instituted a query based on the same resource link device more than once may be redirected to a different site, so that the consumer is sent different information on subsequent entries. The central server tracks a consumer's entries by time as well. The temporal distance between entries may be used to alter the outcome of the algorithm by which the server redirects the user.

In accordance with the present invention, the central server keeps track of users and resource link indicia used to make inquiries. A database thereby developed has marketing value. The usage and sale of the demographic information helps to fund the website and reduce provider costs.

Before a resource link device can be printed on an advertisement, or the like, it must first be generated. At the time of generation, it must be associated with various other elements of information all of which must be input into the system generating the resource link device. Such information may include the location of the advertisement, the magazine where it is placed, the nature of the advertisement (for example, whether it is a poster or a magazine advertisement).

As described above, the resource link device record also provides an association with master account holder supplied data, billing data, procedural data, fields available for consumer supplied information, etc. Printed indicia may also be derived from the resource link device record and is read by the scanner that is employed by the consumer.

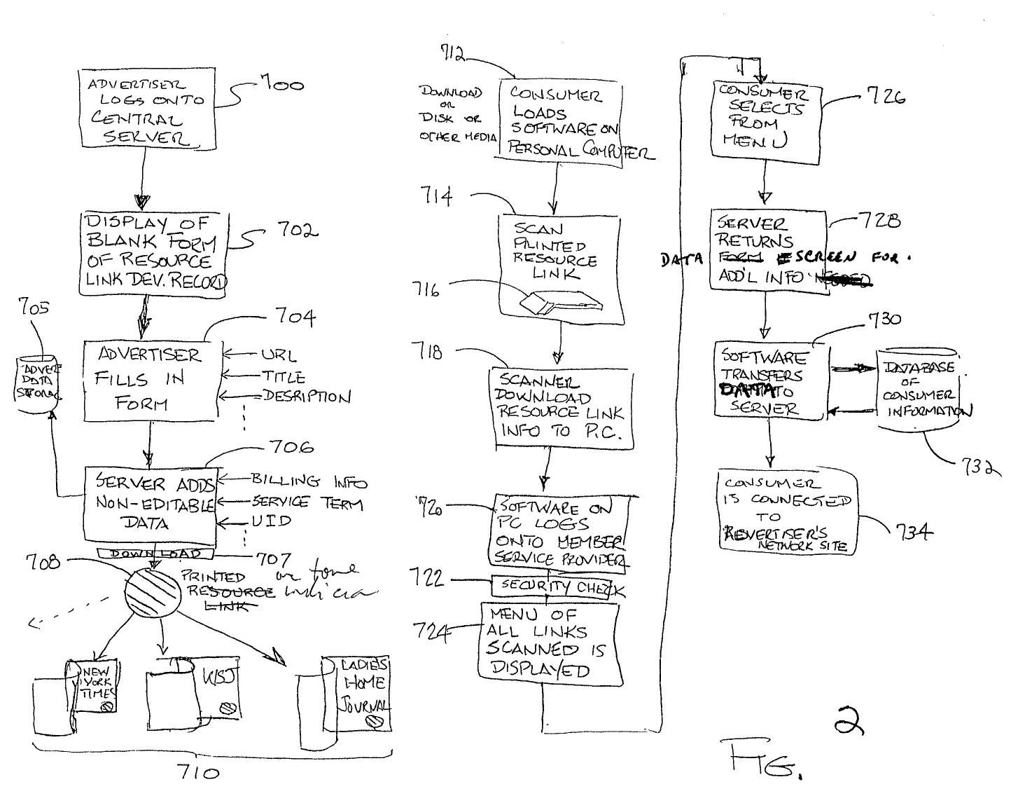

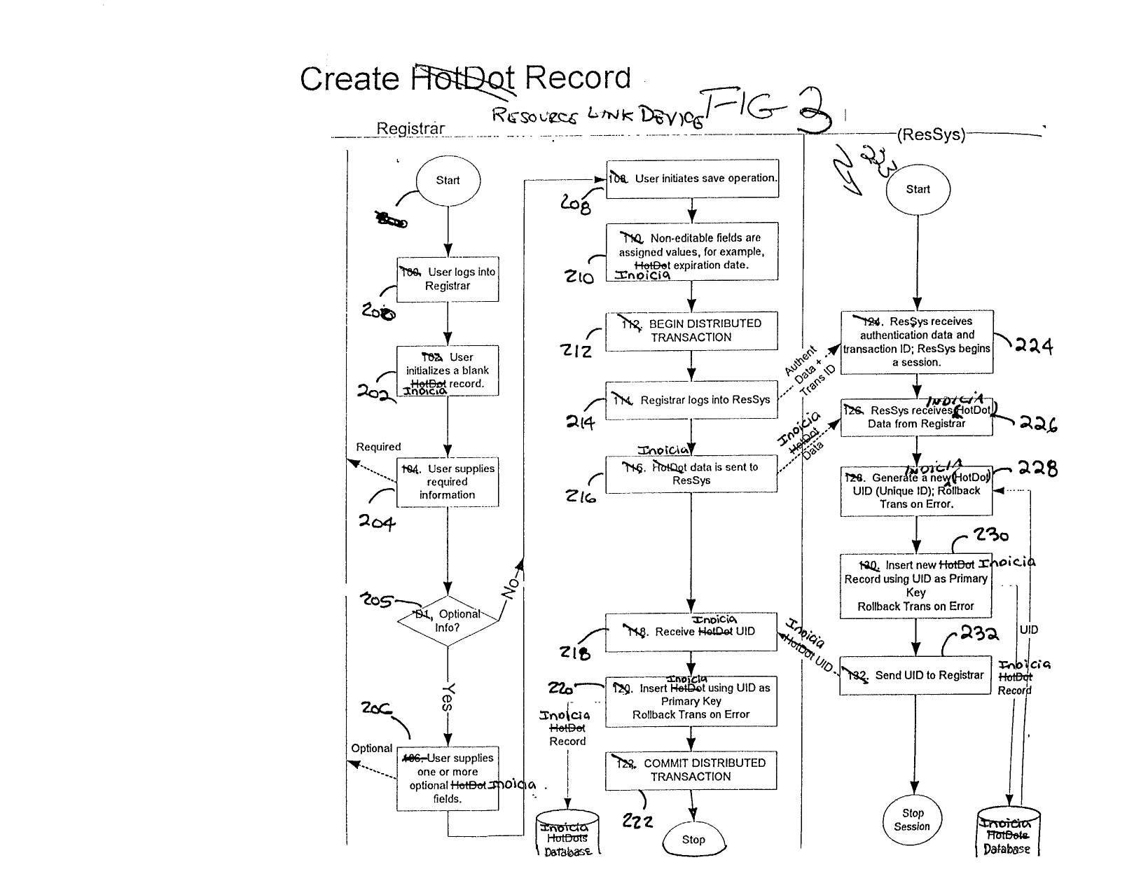

The detailed description of a preferred embodiment described herein is but one implementation of the present invention. We turn now to the details of implementing the invention. The software processes are separated into a plurality of subsystems to implement the present invention. The subsystems are logical divisions. FIG. 2 illustrates an overview of the inventive method. The details of the subsystems employed to implement that overview are described below in association with the description of FIGS. 3 through 7.

FIG. 2 illustrates a method of creating a resource link device record and the usage of same by a consumer. At step 700 a master account holder (for purposes of explanation an advertiser) or other authorized person working on behalf of the advertiser begins the creation of a resource link device record by logging onto a central server. The server subsystems “registrar” and “resolution subsystem” are used in this process as described in further detail in association with FIG. 3. The advertiser is presented with a blank data entry screen for entry of field data to be associated with the resource link device record at step 702. The advertiser fills in the data entry screen with such fields as URL, title, description, etc. as well as by selecting or creating any embedded fields that may require data from the desired consumer. “Location” may be one example of an embedded field. The URL selected for redirection of the consumer may be altered by the information provided for this field by the consumer in accordance with forwarding options to be implemented in the forwarding information bearing hidden fields which may be customized by the advertiser.

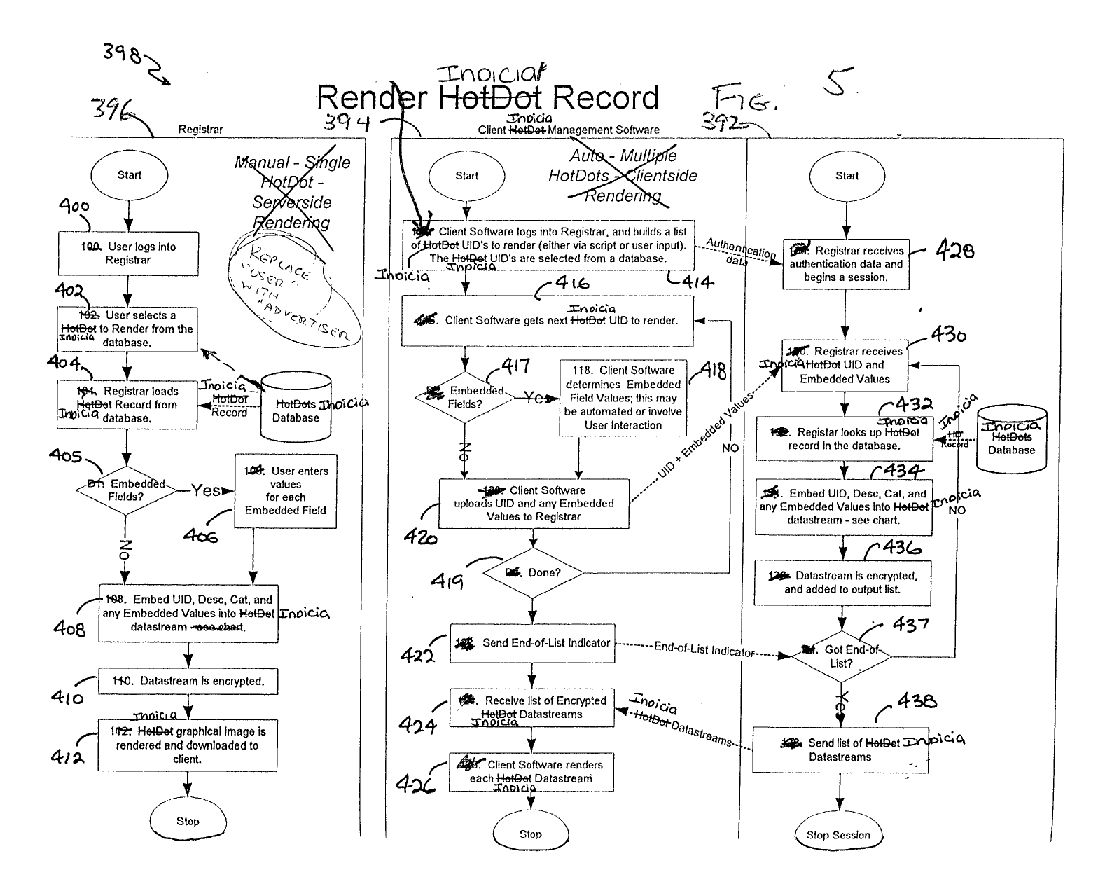

Certain fields of the resource link device record are supplied by the server and are not editable nor enterable by the advertiser. Examples of such server provided field data may be billing information, term of service for the advertiser, the advertiser's Identifier, other procedural data, etc. The resource link device record field data is stored in the server database at step 705. The advertiser may download at step 707 the data necessary to render into print the resource link device or print the same directly from the server. The rendering of the resource link device is described in association with the description of FIG. 5. The printed resource link device 708 may be used as described above and is illustrated as used in various publications at 710.

A consumer will have resource link device software resident on his personal computer. The software (client consumer software) may be downloaded from a network server or installed via other media as is commonly known at step 712. The consumer is supplied with a scanner by a member service provider.

At step 714, the scanner “reads” and stores the resource link device data rendered in the illustrated print media. The subsystems “client consumer software,” “membership services,” “resolution system,” and “resource link scanner” are employed in this process and described in association with the description of FIG. 5. At step 718 the scanner transfers the resource link data to the consumer's personal computer. The client consumer software accesses the Internet and logs onto the member services provider at step 720. Preliminary security checks are performed at 722 to ensure authorizations and authority of the consumer to utilize the resource link device record.

In accordance with the present invention, it is contemplated that the service of linking consumer information through the use of the inventive indicia system will be provided by member service providers who may perform this service from their own website or from a menu provided on a screen provided by a program supplied by the member services provider. The program starts with the consumer signing onto the website of the member service provider and downloading consumer client software which comprises a scanning program which also has all the other software necessary for the consumer to obtain information on using this inventive system. Alternatively, the consumer client software may be bundled as CD-ROM or other medium along with the scanning hardware.

More particularly, the member service provider, in response to downloaded information from the scanner, provides a menu of the data links scanned for display on the consumer's personal computer at step 724. The consumer may select any of the displayed menu entries. In response, the member service provider provides a data entry screen if additional consumer information for named parameters is required to ensure appropriate redirection at step 728. The consumer client software transfers the consumer entered data to the server at step 730, where the data may be stored for future usage at data storage step 732. The consumer is then presented with information from the advertiser's network site at step 734.

FIG. 3 illustrates a method 198 for the creation and editing of a resource link device record in accordance with the present invention. One purpose of a resource link device record is to provide for association of a URL on the world wide web to a unique, 64-bit number that may be encoded in a printed format when the resource link device record is rendered into a printed resource link device. Another aspect of the resource link device records after customization to be associated with a particular consumer, is to store information that is used to build a menu when the resource link device is used by a consumer accessing information through the central server. Thus, the resource link device record, among other aspects described further below, provides the data necessary to print the resource link device and data displayed to the consumer in a menu format when the resource link device is employed to access the central server.

The owner of a resource link devices account, such as an advertiser or a person working with such owner and having sufficient privileges, creates resource link device records at a registrar hosting his account. For the purposes of this description, the creator of the resource link device record will be termed the “advertiser.”

The registrar is a remote location for the registration of resource link device records and regulate the activities of member service providers The advertiser populates the resource link device record with such data as a URL, title to appear on the consumer's menu, a description of the advertiser's service or product, embedded description which will appear in the rendered resource link device, etc. The registrar may also provide, as necessary, advertiser supplied information to a resource link devices resolution server affiliated with the registrar.

While the following description shows a generation of a resource link device record, it is also noted that the invention contemplates the editing of existing resource links. Editing an existing resource link device record is described below as an “alternate embodiment.”

The advertiser logs into the registrar at step 200 to create a resource link device record. At step 202 the advertiser initializes a blank resource link device record data entry screen on his web browser. At step 204, the advertiser supplies a number of fields:

One of these fields may simply be a standard Internet URL, such as http:/ /www.zdnet.com/ zdnn/ stories/news/ 0,4586,2456123,00.html. However, the URL can also contain named parameter tags, enclosed in angle brackets “<” and “>” like html tags, as in the following example: http:/ /www.zdnet.com/ zdnn/ stories/news/ <article_id>.html user_id=<username>;region=<region>

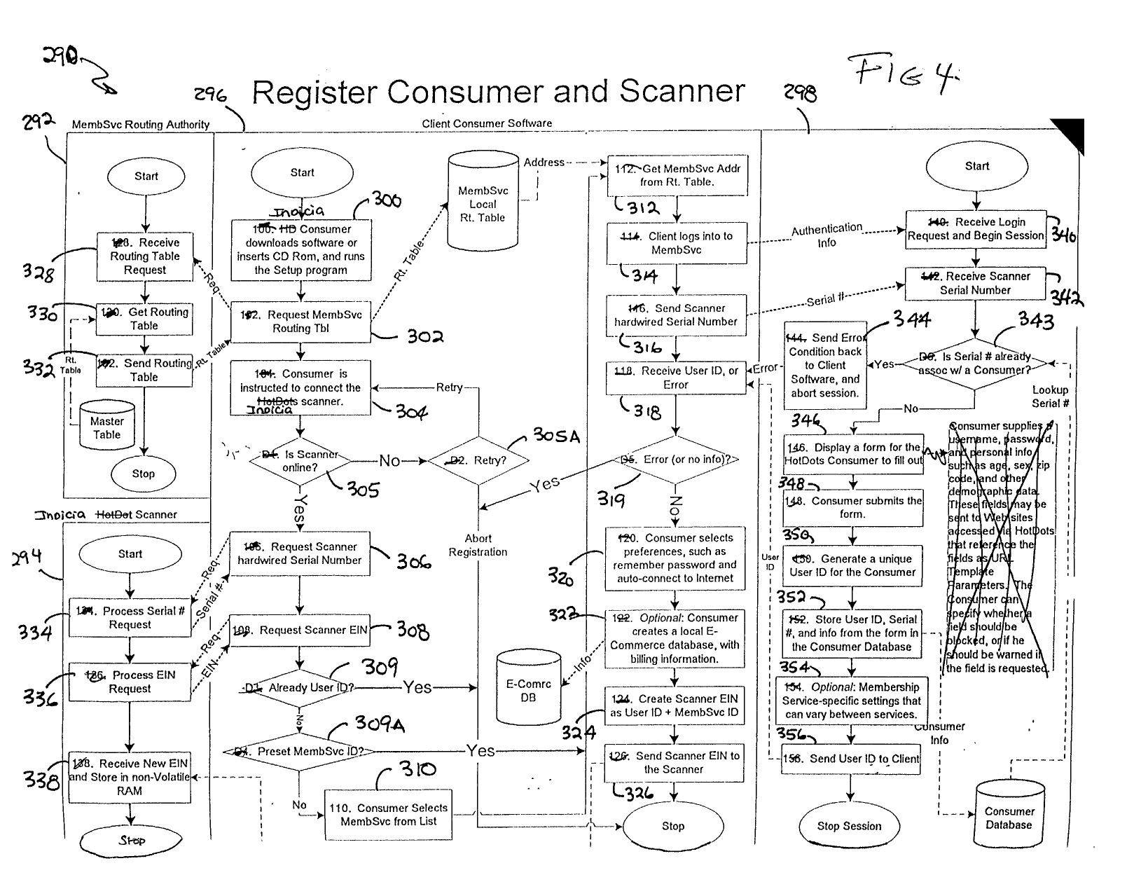

These named parameters can refer to fields, for example, from the consumer demographic database maintained by a membership services supplier described further herein is association with FIG. 4, or a field maintained in the resource link device consumer's own local personal computer database (for example, credit card number), or one of the embedded fields for the current resource link device which are described below.

Thus, the named parameter can function as a placeholder for a string of data that will replace it when building URL during resolution. The named parameter refers to a field in the membership services consumer database, a field in the consumer's local database, or one of the embedded fields for the current resource link device.

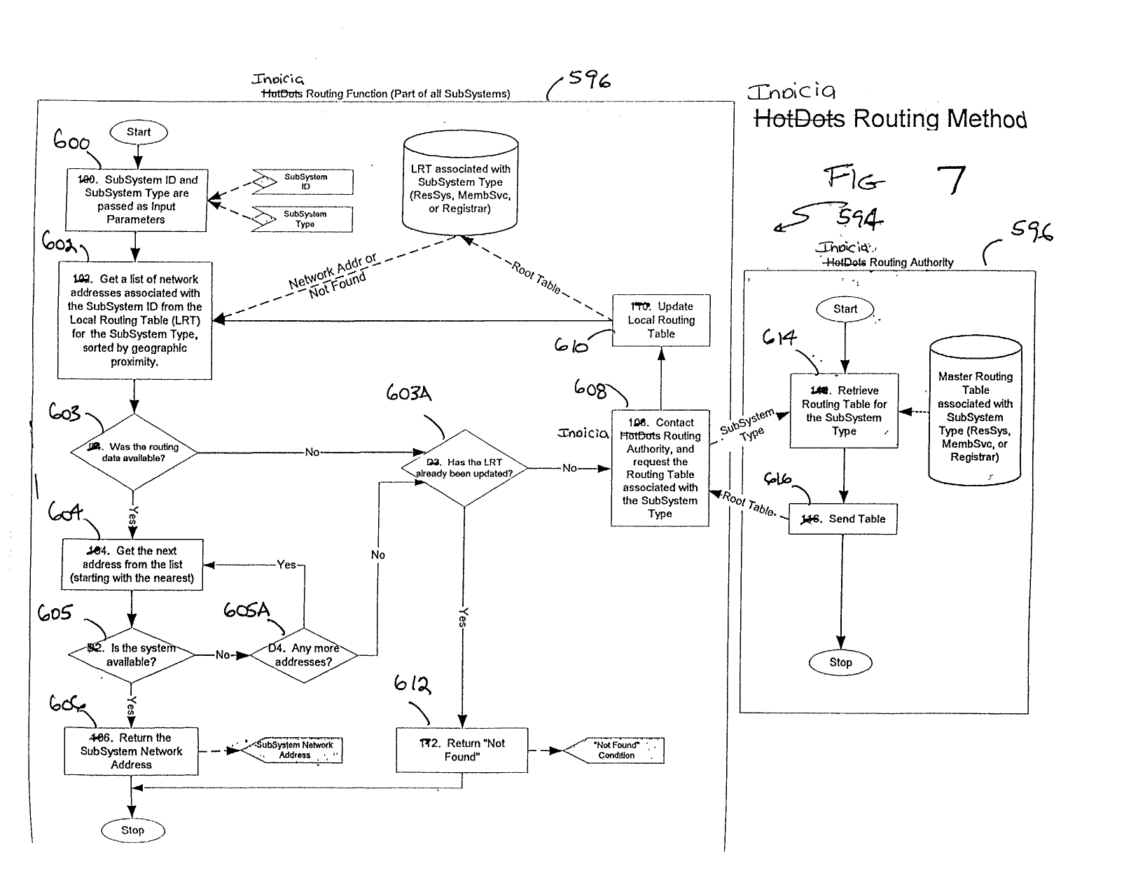

Values for named parameters are employed at different times in the life cycle of a resource link device record. For example, embedded field values may be provided when the resource link device record is rendered (described below in association with FIG. 5, “render resource link device”). Values for consumer demographic fields are provided by the membership services supplier at time of resolution, that is a time when the resource link device is selected from the displayed menu of resource links to institute an inquiry for information associated with the resource link device; values for consumer e-commerce fields may be provided by the consumer client software at resolution time (described below in association with FIG. 7, “resolve resource link device”). When all parameter values have been provided to the resource link device record, the named tags in the URL template are replaced by the corresponding values, producing a standard URL suitable for hyperlinking to any Internet address.

The advertiser provides other resource link device record data which may also include:

A short and long title used to produce the underlined hyperlink in the menu that is presented to the resource link device consumer at resolution time (described below in association with FIG. 7, “resolve resource link device”). The short title is used when the consumer's display device has limited screen real estate, such as a wireless application (WAP)-enabled cell phone or personal desk assistant (PDA); otherwise, the long title is used.

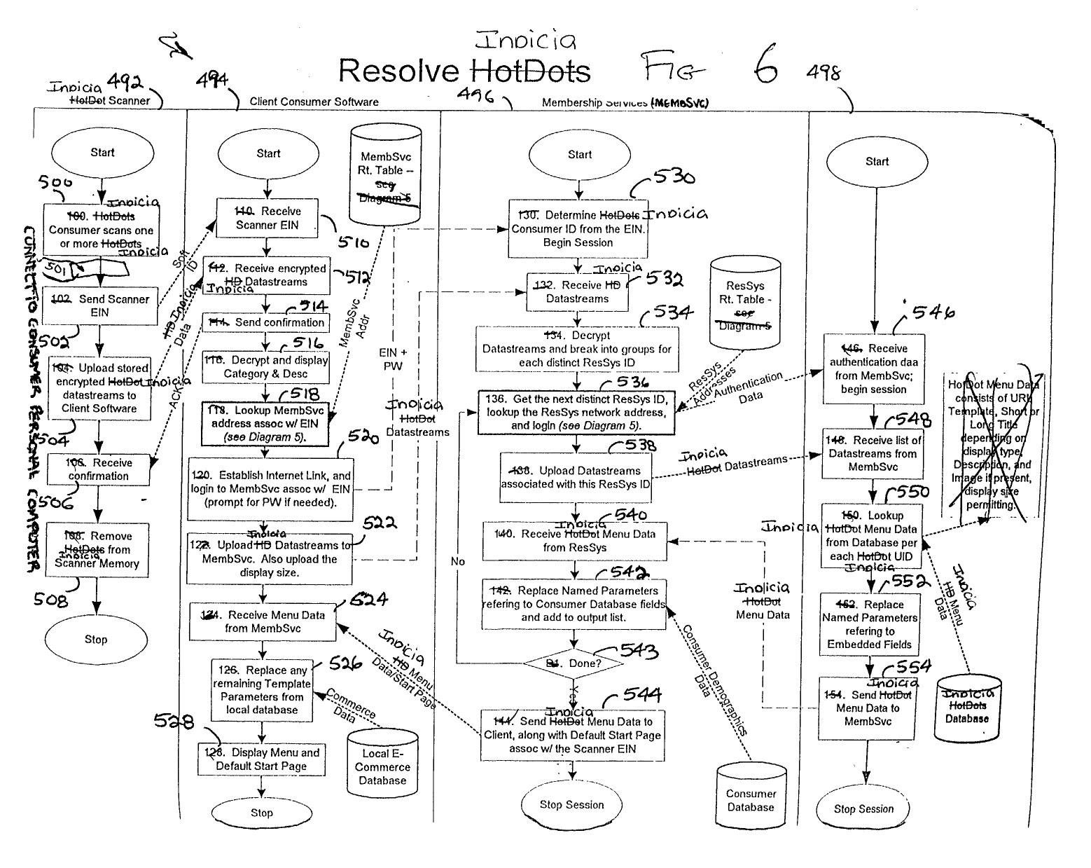

A text string may also be embedded in the rendered resource link device, a similar to a file extension. This string can be displayed as a pictorial icon on the scanner unit if the scanner is so equipped. A dollar sign could indicate a link for an online purchase, a question mark could indicate a link to frequently asked questions, etc. This is analogous to the way the Microsoft Windows or Macintosh operating systems can display different icons for different types of files. A field to hold a brief description of the target web page or Internet resource, to be included in the menu presented to the resource link devices consumer at resolution time (see “resolve resource link device” described below at FIG. 6) may be embedded in the rendered resource link device image. It enables the resource link devices consumer to get limited information on the resource link device's purpose even before he is able to go online to the Internet for resolution. The embedded description may conveniently be displayed on the scanner unit if the scanner is so equipped.

A text string may also be embedded in the rendered resource link device image, similar to a file extension. In this variation of the inventive system, the resource link devices consumer selects an embedded category from a fixed list of choices; his selection is mapped to an appropriate code. The embedded category can be converted into a pictorial icon, such as a question mark for “more information” or a dollar sign for “purchase online.” This icon may also conveniently be displayed on the resource link device consumer's scanning device if the scanning device is so equipped.

In accordance with a preferred embodiment of the invention, as an alternative to choosing from a fixed list, the person registering the resource link device can select an embedded category from a fixed list, which gets converted into a text string.

A symbol such as a check box may be used to indicate that the registrar should periodically check the target web page for meta tags that contain information about the resource link device record (such as title, description, etc.); if these meta tags are updated, the resource link device record is automatically updated with the new information. The only field that can't be automatically updated in this way is the URL of the member service provider.

Referring to FIG. 3, at step 205, if the advertiser chooses, he may supply one or more optional fields. If the advertiser selects the option of adding optional information, the subsystem proceeds to step 206. Examples of optional information include a “category field” wherein the resource link device consumer can choose a category from a hierarchical menu. This category will classify the content into sets of related contents, for example, automobiles, entertainment, technology news, etc.

The resource link device record and allow it to be listed in the online resource link device guide (similar to Yahoo and other web guides). Another optional field may contain keywords where the resource link device advertiser can provide one or more search words to aid in searches on the resource link device database. Further, provision may be made for an image field wherein the resource link device advertiser can choose to upload a small image with standard, designated dimensions and pixel depth, to be displayed in the menu presented to the resource link device consumer at resolution time (described below in association with FIG. 7, “resolve resource link device”). Yet other fields may allow the resource link device advertiser to specify one or more “embedded fields.” Embedded fields allow a resource link device to contain arbitrary data when it is rendered, such as a serial number on a product package or direct mail piece, a date/time stamp, and so on. This information is passed on the target Internet resource (web page, ASP page, CGI script, etc) by referencing the embedded fields using the named parameters method described earlier.

If the resource link device advertiser opts not to add any optional informational fields the subsystem proceeds to save the information at step 208.

After all the resource link device fields have been supplied, non-editable internal fields are assigned by the registrar at step 210 as dictated by the agreement between the registrar business entity and the resource link device master account holder. For example, the resource link device expiration date is assigned, the remaining resource link device counter may be decremented, and billing information may be generated.

At steps 212, 214, and 216 the registrar passes the resource link device record entries as required to a resolution subsystem (races) 223. Races 223 authenticates the information entered into the resource link device record. Races 223 also assigns a unique Identifier (UID) to the resource link device record. Races is described in further detail below.

At steps 218-222 the resource link device record is stored, the transaction is committed, and the database changes are made permanent. If an error is encountered the transaction is rolled back.

Races 223 is also detailed in FIG. 3. At step 224 races receives a login request from the registrar, and begins a new session. Races receives the resource link device data at step 226 from the registrar step 216. Races generates a new unique resource link device Identifier at step 218 by incrementing a master counter, and concatenating a unique Identifier (races ID). If this fails the entire transaction is rolled back across both subsystems, races and registrars. At steps 230 and 232 races inserts the new resource link device record, and sends the new resource link device UID back to the registrar. In this manner a new resource link device record is created.

An alternative embodiment utilizing registrar 198 provides for editing an existing resource link device record. At step 202, the advertiser selects an existing resource link device record for editing and loads a data entry screen with the existing resource link device record values, rather than initializing a blank data entry screen. The registrar proceeds as described above with the variation that the advertiser may edit the displayed fields. Step 210 (non-editable field values) is skipped. At step 216, the resource link device UID, having been previously assigned, as well as edited data is provided to races. Step 218 is skipped the resource link device UID, having been previously assigned. Step 220 is a database update, rather than an insert, operation. Thereafter, races proceeds as above except as follows. Step 228 (generate UID) is skipped because an edited resource link device record already has a UID assigned. Step 230 is a database update, rather than an insert, operation.

In an alternative embodiment, resource link device management software that is resident on the resource link device creator's computer may be employed to automate the process described above. For example, a page layout program may be enhanced so that a resource link device may be embedded in a document without exiting from the central server. Or the advertiser may have his own specialized database that is employed to automatically a create resource link device record via a custom scripting language. Another example may be an enhanced web authoring tool that enables resource link device records to be linked to web pages under development. For example, the resource link device's title may be updated automatically if the web page title changes.

The resource link device record has been created but before the resource link device may be utilized by a consumer, the consumer must first install software on their computer and register themselves and their scanner with a membership services provider. The registration process comprises choosing a membership services provider (which may be “hardcoded” in the scanner), and setting up an account (i.e., choosing a username, password, and providing some personal information, perhaps, such as real name, address, etc.). This information is used during the consumer access of the resource link device subsystem.

There may be numerous membership service providers. This allows consumers to select a provider that will, in turn, provide access to the resource link device subsystem. Each membership services subsystem has a unique Identifier. Some resource link device scanners are preset to work only with a specific membership services subsystem. This gives membership services providers an incentive to distribute and possibly subsidize resource link device scanners.

The registration process 290 is illustrated in FIG. 4. Registration process 290 is divided into four subsystems: client consumer software 296, member services routing authority 292, resource link device scanner 294, and membership services 298.

Client consumer software is generally shown as 296 in FIG. 4. At step 300 the prospective resource link device consumer loads software onto his local personal computer. This, may be achieved by any of well known methods including via CD-ROM, floppy disks, other media containing the resource link device client software, or a download of the software via the Internet. The consumer runs the software “setup” program. The setup program performs the various housekeeping tasks associated with software installation for the client computer platform including copying files to the consumer's hard disk, updating system databases (such as the windows registry), etc. The setup program then invokes the newly installed client software registration procedure that follows below.

At step 302 the client software establishes a connection with the Internet via the consumer's Internet service provider, modem, or any other such Internet access system. The client software establishes a connection with a routing authority (described in detail below) responsible for maintaining membership services addresses, and requests a copy of a membership services routing table. The client software receives the routing table, and stores a local copy of the routing table on the consumer's personal computer. The “resource link device routing method” architecture is described in detail below in association with the description of FIG. 7.

The consumer is instructed to connect the resource link device scanner 16 in FIG. 1 to computer 18 via an appropriate port (for example, the RS232 serial port) at step 304. The client software attempts to detect the scanner at step 305.

If the client software can not detect the scanner, the subsystem proceeds to step 305a wherein the consumer is asked whether he would like to retry detecting the scanner. If he indicates “yes,” the subsystem returns to step 304. Otherwise, the setup is aborted.

If detection of the scanner is successful at step 305 the client software requests, at step 306, scanner 16 to provide the hardwired scanner serial number. All resource link device scanners have a unique serial number stored in ROM (read only memory) that cannot be altered. The client software receives and stores this number.

At step 308 the client software requests scanner 16 to provide the scanner electronic identification number (electronic Identifier number). This is a data string that may be stored in non-volatile RAM (meaning that it can be overwritten but does not require a power source to maintain the stored data string) on the scanner. The electronic identification number is used to track the resource link device consumer identifier, and membership services identifier described further below.

At step 309 the client software checks to see if there is already a consumer identifier present in the electronic identification number. For security purposes the consumer identifier is blank when scanners are shipped from the factory. In this manner it is more difficult to steal and reinitialize a resource link device scanner. If there is already a consumer identifier, and the consumer identifier is not equal to the consumer's own identifier and the consumer had already registered, abort the registration process. A message may be returned for display explaining that the scanner has already been registered to another user.

At step 309a the client software checks to see if there is a preset membership services identifier present in the electronic identification number. If there is a preset membership services identifier, store this for later use, and proceed to step 312. If not, go to step 310 wherein the consumer selects a membership services provider from a list of available choices presented on the consumer's personal computer display by the client software. This may involve visiting a web site designed for this purpose. The consumer will have an opportunity to sample and compare the different services before he makes the decision as to which membership services provider the consumer prefers. Once the consumer chooses a membership services provider, the membership services identifier is stored by the client software.

At step 312 the client software looks up the network address of the membership services provider in the local membership services routing table given the membership services identifier stored. The consumer is logged into a membership services subsystem 298 using the address just obtained at step 314. At step 316 the client software sends the scanner's hard-wired serial number obtained earlier to the membership services subsystem.

The client software receives either a valid resource link device consumer identifier or an error condition from membership services subsystem 298 at step 318. A valid consumer identifier indicates that the consumer completed a successful registration session with the membership services subsystem (described below).

If an error is received from membership services subsystem 298 (or no information was received after a designated time period), display an appropriate message, and abort the registration process at step 319. If no error is received the consumer selects personal preferences that affect the behavior of the client software at step 320. For example, the software may be configured to auto-connect to the Internet whenever the scanned indicia are unloaded from the scanner to the computer.

Also, the consumer may wish to have his password remembered for subsequent logins to membership services subsystem 298.

If desired, an optional step 322 allows the consumer to choose to set up a local database to store sensitive information for use during e-commerce operations, such as billing address and credit card number. This database may be accessed during resource link device resolution (described below in association with the description of FIG. 7) for resource link device records that request this information in the URL template.

If the set-up is successful at step 324 the client software creates a scanner electronic identification number containing the stored consumer identifier and membership services identifier. At step 326 the client software provides the scanner electronic identification number to the scanner, and a message may be displayed to the consumer indicating successful setup and registration of the client software and scanner.

Referring again to FIG. 4, membership services routing authority subsystem is generally shown as 292. Membership routing authority receives a request from the client software for the membership services routing table at step 328. At step 330, the routing authority retrieves the master routing table from storage and sends the routing table to the client software at step 332.

Also in FIG. 4, resource link device scanner subsystem is generally shown as 294. The scanner receives a request for the hard-wired serial number from the client software at step 334. The scanner retrieves and provides the serial number to the client software. At step 336, the scanner receives a request for the electronic identification number from the client software then retrieves and provides same to the client software. The scanner receives a new electronic identification number from the client software at step 338 and stores same in non-volatile RAM, overwriting the previous electronic identification number.

Further in FIG. 4, device membership services subsystem is generally shown as 298. Membership services 298 receives a login request from the client software and begins a session at step 340. The hard-wired serial number of the scanner is received from the client software at step 342. At step 343 the subsystem determines if the serial number is already associated with a resource link device consumer. If this is true, the subsystem proceeds to step 344 where an error message is sent to the client software indicating that the scanner has already been registered to another person (this is a measure to prevent unauthorized scanner use and theft), and the session is aborted.

If the scanner serial number is not already associated with a resource link device consumer at step 342, the subsystem proceeds to step 346 wherein membership services instructs the client software to launch a web browser session. Membership services loads a browser data entry screen in the browser where the data entry screen is displayed for the consumer to enter data fields, as necessary, to aid in redirection to an appropriate advertiser website. The consumer selects a username and password. The consumer also supplies personal demographic data, such as age, sex, zip code (or other locale information), and other related items. The consumer can specify which fields should be blocked; which should always be sent; and which he should be warned on each request at resolution time (described in further detail below in association with the description of FIG. 6). This information is also used to generate demographics reports that the membership services provider may sell to interested parties.

Ultimately, the consumer submits the filled in data entry screen to membership services at step 348 and membership services generates a unique consumer identifier for the resource link device consumer at step 350. The consumer identifier, scanner serial number, and the information gathered from the browser data entry screen are stored in the resource link device consumer database at step 352. The database is accessed at resource link device resolution time.

Optionally, different membership services providers can supply their own custom registration steps. For example, the consumer may have his own personal resource link device created or be given the ability to create his own home page or e-business card with the resource link device embedded in the home page or business card. This is represented at step 354.

The new consumer identifier is sent to the client software at step 356 and represents a successful registration.

Once a resource link device record is created, it needs to be converted into the actual printable graphical image. This conversion process is called “rendering.” FIG. 5 illustrates a flowchart of a rendering process 398. If the resource link device record has any embedded fields, values for those fields are supplied at this time. Rendering may be accomplished while on-line by the registrar website. Alternatively, rendering may be automated via specialized resource link device management software that communicates with the registrar server.

These alternatives are discussed in detail below.

Referring to FIG. 5, rendering on the registrar website is illustrated as 396. First, the advertiser logs onto the registrar website at step 400. The registrar retrieves and displays a menu of resource link devices available to the advertiser. The advertiser selects a resource link device to render from the menu of resource link devices at step 402. The registrar loads the resource link device record from the database at step 404 and displays the record to the advertiser. The registrar searches the resource link device record for embedded fields at step 405. If there are embedded fields, the advertiser can fills out a data entry screen containing fields for each embedded field associated with this resource link device record at step 406. The subsystem then proceeds to step 408. If there are no embedded fields at step 405 the registrar subsystem proceeds to step 408 wherein the resource link device UID (unique Identifier), embedded description, embedded category, and any embedded field values from step 406 are incorporated into a resource link device datastream. For advertiser safety, the resource link device datastream is encrypted at step 410. At step 412 the registrar generates a resource link device graphical image and the image is downloaded to the client web browser.

Alternatively, rendering may be automated via specialized resource link device management software that communicates with the registrar server as illustrated as 394. This database could be any form of persistent data storage deployed at the advertiser's site. For example, the database could be a simple flat file, or be part of an enterprise-wide database management system. In this case the client software resident on the advertiser's personal computer or other network connection device, not the registrar subsystem, is responsible for the generation of the graphical image. This software can manage hundreds or even thousands of resource link devices, and automate the creation, modification, rendering, and deletion of resource link devices. For example, a scripting language may be written to allow custom batch operations, such as batch rendering a resource link device with an embedded field, automatically generating unique values each time. This software may also be integrated with web or print publishing software.

At step 414 the client software logs onto the website running the registrar subsystem and builds a list of UID's from a database. This database could be any form of persistent data storage deployed at the advertiser's site. For example, the database could be a simple flat file, or be part of an enterprise-wide database management system. UID's are stored, not entire link device records, because only the UID is needed to access the link device record at the Registrar. The UID is a unique lookup to the Registrar database, providing a useful alternative to storing all the fields in the link device record in the advertiser's local database, which could be redundant and be more complex to maintain.

At step 416 the client software gets the next resource link device UID to render from the list. If there any embedded fields in the current resource link device found at step 417 the subsystem proceeds to step 418 wherein the client software determines the values to place in the embedded fields. These embedded values may be supplied in a number of ways: the embedded values may have already been specified and is held and retrieved from a database; the embedded values may be supplied interactively from the advertiser; or the embedded values may be automatically generated via scripting language code. After the embedded fields data has been provided, the registrar subsystem proceeds to step 420.

If there are no embedded fields found at step 417 the registrar subsystem proceeds to step 420 wherein the client software uploads the device UID, and any embedded field values from step 418.

At step 419 the subsystem determines of there are more resource link device UID's in the list. If so, the subsystem loops back to step 416. When all of the resource link devices are completed the subsystem proceeds to step 422 where an indicator is sent to the registrar that there are no more resource link device UID's to be sent. In response, the registrar returns a list of encrypted resource link device data streams at step 424. The client software decrypts and renders each resource link device datastream, producing the final resource link device graphical image, and stores the image, as appropriate, such as in a database, a file, or embedded within a document at step 426.

After a consumer has scanned one or more resource link device with his scanning device, he links the scanner to a computer subsystem running the resource link device client software. The software downloads the decoded resource link device data streams from the scanner, sends the data streams to the resource link device membership services provider determined at registration described above, and receives information used to create a menu of clickable hyperlinks based on the resource link devices scanned. The membership services provider communicates with one or more resource link device resolution servers to accomplish this task.

FIG. 6, illustrates the “resolve resource link device” process 490. The resource link device scanner subsystem is illustrated as 492 in FIG. 6. The consumer scans one or more resource link devices at step 500. These are stored in the resource link device scanner internal memory. When the consumer has scanned the desired resource link devices, the consumer connects the resource link device scanner to a computer subsystem containing the resource link device client software at step 501. The scanner sends the electronic identification number to the client software at step 502. The electronic identification number is stored in non-volatile RAM and can be modified. The electronic identification number is used to determine which membership services subsystem to connect with, to identify the resource link device consumer, and to identify the default start page.

At step 504 the scanner uploads the data streams for each scanned resource link device. These data streams have already been extracted from the resource link device graphical images, and are in an encrypted state. The scanner receives confirmation that the upload was successful at step 506. Upon confirmation of successful upload at step 506 the scanner removes the resource link device data streams from memory.

The client consumer software (“client”) is illustrated as 494 in FIG. 6. The client receives the scanner electronic identification number of step 502 at step 510 and the encrypted resource link device data streams of step 504 at step 512. The client sends a confirmation message to the scanner that the upload was successful at step 514. The subsystem decrypts the embedded description and embedded category portion of the resource link device data streams and displays them at step 516. The client may be configured to wait for the consumer to signal “OK” before proceeding, or may proceed automatically.

The client looks up the membership services (“membsvc”) at step 518 in the local routing table. The local routing table maintains a database of membsvc website addresses. If the address is not found the client goes online and connects to a central routing server (see the routing method subsystem described below) wherein a master list of membsvc website addresses is maintained.

At step 520 the client establishes an Internet link, and logs into membsvc, sending the scanner electronic identification number to identify the consumer, and the default start page. The consumer may be prompted for a password. The client uploads the resource link device data streams received from the scanner to membsvc at step 522. The personal computer display size is received as well since this will determine the amount of information that can be displayed.

The client receives the resource link device menu data associated with the uploaded resource link device data streams at step 524. The menu data consists of the URL template, short or long title (depending on the display size), description, and optional image for each scanned resource link device if the display size permits. The subsystem fills in any template values for any remaining named parameters that reference the consumer's local database. The consumer may choose to keep sensitive data such as his credit card number on his local computer system rather than uploading this information to the membership services subsystem. These get replaced with actual values at this time.

The client displays the resource link device menu, and the default start page associated with the scanner electronic identification number at step 528. The consumer can now click on any of the hyperlinks in the menu and be taken to the target website resources associated with the resource link device he scanned.

Preferably, when the consumer clicks on a menu item, they are not taken directly to the target Web Site. Rather, the resource link device is sent back to Membsvc.

Membsvc can at this point attempt to replace any named parameters that reference the consumer database (for example Step 542), and generate the data entry screen described above, if necessary. Membsvc can update a usage database that correlates demographic information with link device records. Membsvc can also send a request to Ressys to increment a counter in the link device record indicating how many times a consumer actually accessed the target site. Finally Membsvc can take the consumer to the target Web site.

The membership services subsystem is illustrated as 496 in FIG. 6. Membsvc receives a login request from the client at step 530, determines the resource link device consumer Identifier from the passed electronic identification number, and begins a session. One of the sub-fields of the electronic identification number is the consumer identifier as described above. Membsvc also receives the resource link device data streams from the client at step 532. Each resource link device datastream is decrypted at step 534 and the resolution server (“races”) identifier for each datastream is determined. The races identifier is a unique identifier that is a part of the resource link device UID embedded in the datastream. Each races identifier corresponds to one of the resolution servers that are responsible for looking up resource link device menu data. Membsvc groups the data streams according to each distinct races identifier.

At step 536 membsvc gets the next distinct races identifier and its associated list of resource link device data streams and determines the races address from the local routing table. If the address is not found, a central routing server is contacted over the network (see, also, the resource link device routing function described below in association with the description of FIG. 7). Otherwise, an Internet link is established with races.

After logging onto the ressys, membsvc uploads the resource link device data streams associated with the current races identifier at step 538. In response, membsvc receives the resource link device menu data records associated with the uploaded resource link device data streams. Step 542 (accessing the consumer database) need not occur at this time. Rather it can occur when the consumer actually clicks on the menu item, as described above. This will be reflected in the updated flowcharts.

At step 543 the subsystem loops back to step 536 unless the last races identifier from the uploaded resource link device data streams has been processed. If completed, the subsystem sends the resource link device menu data output list to the client, along with the default start page associated with the scanner electronic identification number at step 544.

The resolution system (“races”) is illustrated as 498 in FIG. 6. At step 546 a login request is received from membsvc and a session begins. Races then receives a list of resource link device data streams from membsvc at step 548. Races looks up a resource link device record given the UID from each datastream at step 550. For each datastream, construct a resource link device menu data record containing the URL template, short or long title (depending on the display size), description, and optional image. The description and image are only included if the display size permits. At step 522 replace named parameters in each URL template that refer to an embedded field within the resource link device datastream. Each resource link device datastream may have different embedded fields and therefore a different set of named parameters. Ressys then increments a counter in the resource link device record indicating how many times the record has been scanned by a consumer, but not necessarily visited. Once completed, send each resource link device menu data record to membsvc at step 554.

The resource link device routing method is illustrated as 594 in FIG. 7. The purpose of the routing method is to describe a standard method for resolving resource link device subsystem identifiers into actual network addresses. Each membership services subsystem, resolution subsystem, and registrar subsystem have a unique Identifier independent of any “hard” network address.

The routing method consists of two primary subsystems. The first section describes the routing function 596 as a system invokable by any of the resource link device sub systems. This function communicates with the central resource link device routing authority. The second section describes the routing authority 598 as a subsystem responsive to routing function 596.

The local routing table (LRT) that contains routing information for the specified subsystem type is accessed at step 602. This provides the information necessary to create a list of network addresses associated with the given subsystem identifier, ordered such that the first network address is the geographically closest and the last address is the furthest away. At step 603 the list is checked to determine if an address was available. If so, the subsystem gets the next address from the list, starting with the geographically nearest at step 604. At step 605 the routing function checks if the calling system is online and available. If so, the current network address is returned to the calling function at step 606.

If no address was found at step 603, the routing function determines at step 603a if the LRT has already been updated during this process. If not, the routing function proceeds to step 608 where the resource link device routing authority is contacted and a request is made for the routing table associated with the given subsystem type. Thereupon the new local routing table is received from the routing authority. The LRT is updated at step 610 with the data just received and the routing function returns to step 602.

If the LRT was already updated as found at step 603a, then the routing function returns an “address not found” notice to the calling function at step 612.

If at step 605 the routing function finds that the calling function is not online/available, it determines at step 605a if there are any more network addresses in the list. If more addresses are on the list then the routing function loops back to step 604 for the next address. If there no more addresses on the list, the routing function proceeds to step 603a to determine if the LRT has been updated as described above.

At step 614 routing authority 598 responds to a request routing function for a routing table. The routing authority retrieves the routing table from the master routing table 615 for a given subsystem type. LRT contents of the master routing table are returned to the requesting subsystem at step 616.

The present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation wherein, when the computer program code is loaded into and executed by a computer, the computer becomes an apparatus for practicing the invention. When implemented on a general-purpose microprocessor, the computer program code segments configure the microprocessor to create specific logic circuits.

While a preferred embodiment has been shown and described, various modifications and substitutions may be made thereto without departing from the spirit and scope of the invention. Accordingly, it is to be understood that the present invention has been described by way of illustration and not limitation.

1. A method for supplying information to consumers on request, comprising the steps of:
(a) composing an optically readable indicia;
(b) applying said optically readable indicia to an object;
(c) optically scanning said indicia to generate an electronic representation of said indicia;
(d) storing said electronic representation of said indicia, said storing being done by a device used to perform said optical scanning;
(e) downloading said electronic representation of said indicia to a computing device;
(f) causing said computing device to communicate a signal to a central server, said signal including information to identify said optically readable indicia;
(g) programming said central server to associate said optically readable indicia with a plurality of addresses in response to selected criteria, whereby said optically readable indicia is associated with different addresses in response to differences in said selected criteria;
(h) said central server being responsive to said signal i) to contact a server at an address associated with said signal and said optically readable indicia, and ii) obtain information from said server associated with said address and communicate said information received from said server associated with said address to said computing device for display or other use at said computing device.

2. A method as in claim 1, wherein said central server is responsive, to said signal to contact said server at an address associated with said signal and said optically readable indicia, and to the number of times of said contacting of said server.

3. A method as in claim 1, wherein said criteria comprises differences in location of said printed indicia, whereby said optically readable indicia is associated in response to differences in the location of said printed indicia with different addresses.

4. A method as in claim 1, wherein said criteria comprises differences in location of consumer, whereby said optically readable indicia is associated in response to differences in the consumer's location with different addresses.

5. A method as in claim 1, wherein said composing an optically readable indicia comprises;
(a) creating a database record on a central server by a database record owner;
(b) providing database fields to associate said database record with a network address;
(c) populating certain of said database fields with data supplied by said database record owner;
(d) populating certain of said database fields with data supplied said central server; and
(e) printing said optically readable indicia.

6. A method as in claim 5, wherein said printing comprises downloading an electronic representation of said optically readable indicia to said database record owner.

7. A method as in claim 5, wherein said printing comprises printing of said optically readable indicia by said central server.

8. A method as in claim 1, wherein said criteria comprises differences in time, whereby said optically readable indicia is associated in response to differences in time with different addresses over time.

9. A method for supplying information to consumers on request, comprising the steps of:
(a) composing an optically readable indicia containing information respecting a plurality of different elements;
(b) applying said optically readable indicia to an object;
(c) using a scanning device to optically scan said indicia and generate an electronic representation of said indicia;
(d) storing said electronic representation of said indicia, said storing being done by said device used to perform said optical scanning;
(e) downloading said electronic representation of said indicia to a computing device;
(f) causing said computing device to communicate a signal to a central server, said signal including information to identify said optically readable indicia;
(g) programming said central server to associate said optically readable indicia with a plurality of addresses in response to selected criteria selected from said information respecting a plurality of different elements, whereby said optically readable indicia is associated with different addresses in response to differences in said selected criteria;
(h) said central server being responsive to said signal
i) to contact a server at an address associated with said signal and said optically readable indicia at the time of said contacting of said server, and
ii) obtain information from said server associated with said address and communicate said information received from said server associated with said address to said computing device for display or other use at said computing device.

10. A method for supplying information to consumers on request, as in claim 9, wherein a consumer specific record is generated in response to the communication of said signal to said central server.

11. A method for supplying information to consumers on request, as in claim 10, wherein said consumer specific record contains information identifying such consumer.

12. A method for supplying information to consumers on request, as in claim 11, wherein said information identifying such consumer is identification data contained on the hard drive of said computing device.

13. A method for supplying information to consumers on request, as in claim 9, wherein said indicia is a bar-code.

14. A method for supplying information to consumers on request, as in claim 9, wherein said communication causes the downloading of information responsive to particular consumer attributes and/or information and coded with an set signal, and/or a direct site address.

15. A method for supplying information to consumers on request, as in claim 9, wherein said communication results in transfer of the inquiry to a site unrelated to a site associated with the optically readable indicia scanned by the consumer.

16. A method for supplying information to consumers on request, as in claim 15, wherein said transfer to said unrelated site is accompanied by an explanation to the consumer.

17. A method for supplying information to consumers on request, as in claim 15, wherein said transfer to said unrelated site is accompanied by a payment to an individual associated with the composing of said optically readable indicia.

18. A method for supplying information to consumers on request, comprising the steps of:
(a) composing an indicia containing information respecting a plurality of different elements;
(b) incorporating said indicia into an audiovisual production;
(c) using a device capable of detecting said indicia to generate an electronic representation of said indicia;
(d) storing said electronic representation of said indicia, said storing being done by said device used to perform said optical scanning;
(e) downloading said electronic representation of said indicia to a computing device;
(f) causing said computing device to communicate a signal to a central server, said signal including information to identify said indicia;
(g) said central server being responsive to said signal
i) to contact a server at an address associated with said signal and said indicia, and
ii) obtain information from said server associated with said address and communicate said information received from said server associated with said address to said computing device for display or other use at said computing device.

19. A method for supplying information to consumers on request, as in claim 18, wherein a plurality of addresses are associated with said signal and said server is contacted and produces address information in response to selected criteria, said criteria being selected from said information respecting a plurality of different elements, whereby said indicia is associated with different addresses in response to differences in said selected criteria.

20. A method for supplying information to consumers on request, as in claim 18, wherein said indicia is an audio cue.

21. A method for supplying information to consumers on request, as in claim 18, wherein said indicia is a pattern displayed on the cathode ray tube of a television screen.

22. A method for supplying information to consumers on request, as in claim 18, wherein said indicia is a series of flashes of various duration produced by the cathode ray tube of a television set.

23. A method for supplying information to consumers on request, as in claim 18, wherein said indicia comprises a sequence of tones having different frequencies.

24. A method for supplying information to consumers on request, as in claim 18, wherein said indicia comprises a number of tones of different frequencies output by said audio device simultaneously.

25. A method for supplying information to consumers on request, as in claim 18, wherein said indicia comprises a sequence of tones having different frequencies, and additional tones output during the output of said sequence at frequencies different from the tones of said sequence.

26. A method for supplying information to consumers on request, as in claim 18, wherein said indicia are transmitted periodically during the course of an audiovisual program that correspond to content related to the substance of said program.

27. A method for supplying information to consumers on request, as in claim 18, wherein said indicia are transmitted periodically during the course of an audiovisual program and have a content that correspond to the particular portion of the program approximately during which they are transmitted.

28. A method according to claim 1 wherein the optically readable indicia comprise invisible ink barcoding or digital watermarking.

29. A method according to claim 1 wherein the indicia are readable by a magnetic or other non-optical device.
